(19) United States
(12) Patent Application Publication
(10) Pub. No.: US 2013/0114287 A1
(43) Pub. Date: May 9, 2013

(54) ILLUMINATED KEYBOARD

(71) Applicant: Chung-Yuan Chen, Taipei (TW)

(72) Inventor: Chung-Yuan Chen, Taipei (TW)

(73) Assignee: PRIMAX ELECTRONICS LTD., Taipei (TW)

(21) Appl. No.: 13/367,126

(22) Filed: Feb. 6, 2012

(30) Foreign Application Priority Data
Nov. 4, 2011 (TW) 100140307

(51) Int. Cl. G09F 13/04

(52) U.S. Cl. 362/602

(57) ABSTRACT

An illuminated keyboard includes plural keys, a membrane switch circuit member and an illumination module. The illumination module is used for emitting plural light beams. When the membrane switch circuit member is triggered by depressing a key, the membrane switch circuit member issues a corresponding key signal. The membrane switch circuit member includes plural light-guiding zones. At least one light-guiding zone of the plural light-guiding zones has a light-guiding structure. The light-guiding structure of the at least one light-guiding zone is not aligned with the corresponding key intersection. Under this circumstance, the light beams from the illumination module are not sheltered by the corresponding key intersections, and thus the light beams can be fully utilized.

### FIELD OF THE INVENTION

The present invention relates to a keyboard, and more particularly to an illuminated keyboard with an illuminating function.

### BACKGROUND OF THE INVENTION

A keyboard is one of the widely-used computer peripheral devices. Via the keyboard, the user may input characters and instructions into a computer. FIG. 1 is a schematic top view illustrating the outward appearance of a conventional keyboard. The surface of the conventional keyboard 1 includes plural keys 10. These keys 10 are classified into several types, e.g. ordinary keys 101, numeric keys 102 and function keys 103. When one or more keys are depressed by a user, a corresponding signal is issued to the computer, and thus the computer executes a function corresponding to the depressed key or keys. For example, when an ordinary key 101 is depressed, a corresponding English letter or symbol is inputted into the computer. When a numeric key 102 is depressed, a corresponding number is inputted into the computer. In addition, the function keys 103 (F1˜F12) can be programmed to cause corresponding application programs to provide certain functions.

With the maturity of the computing technologies, the conventional keyboard that has basic functions fails to meet the requirements of various users. For this reason, the keyboard manufacturers make efforts in designing novel keyboards with diversified functions. Recently, an illuminated keyboard with an illuminating function has been disclosed. Since the outward appearance of the conventional illuminated keyboard is similar to the outward appearance of the conventional keyboard 1, only the inner structure of the conventional illuminated keyboard will be illustrated in more details as follows.

FIG. 2 is a schematic cross-sectional view illustrating a conventional illuminated keyboard. As shown in FIG. 2, the illuminated keyboard 2 comprises plural keys 20, a membrane switch circuit member 21, a light guide plate 22, an illumination module 23, a main circuit board 24, a reflector 25 and a base plate 26. The key 20 comprises a keycap 201, a key housing 202 and an elastic element 203. From top to bottom, the keycap 201, the key housing 202, the elastic element 203, the membrane switch circuit member 21, the light guide plate 22, the reflector 25 and the base plate 26 of the conventional illuminated keyboard 2 are sequentially shown. The main circuit board 24 is arranged at a second side of the membrane switch circuit member 21. The illumination module 23 is arranged at a first side of the membrane switch circuit member 21.

In the key 20, the keycap 201 is exposed outside the surface of the illuminated keyboard 2, so that the keycap 201 can be depressed by the user. The key housing 202 is used for fixing the keycap 201 and the elastic element 203. The elastic element 203 is penetrated through the key housing 202. In addition, both ends of the elastic element 203 are contacted with the keycap 201 and the membrane switch circuit member 21, respectively. The membrane switch circuit module 21 comprises an upper wiring board 211, a partition plate 212 and a lower wiring board 213. Each of the upper wiring board 211, the partition plate 212 and the lower wiring board 213 is made of a transparent material. The transparent material is for example polycarbonate (PC) or polyethylene (PE). The upper wiring board 211 has plural upper contacts 2111. The partition plate 212 is disposed under the upper wiring board 211, and comprises plural partition plate openings 2121 corresponding to the plural upper contacts 2111. The lower wiring board 213 is disposed under the partition plate 212, and comprises plural lower contacts 2131 corresponding to the plural upper contacts 2111. The plural lower contacts 2131 and the plural upper contacts 2111 are collectively defined as plural key intersections. Moreover, the membrane switch circuit module 21 is connected with the main circuit board 24 for transmitting first electric power and signals.

The illumination module 23 comprises an illumination circuit board 231 and plural light-emitting elements 232. For clarification and brevity, only a light-emitting element 232 is shown in the drawing. The illumination circuit board 231 is arranged at the first side of the membrane switch circuit member 21 for providing second electric power to the plural light-emitting elements 232. The light guide plate 22 has plural light-guiding zones 221. Each of the light-guiding zones 221 has plural light-guiding dots 2211. The light-guiding dots 2211 of each light-guiding zone 221 are uniformly distributed. In addition, each light-guiding zone 221 has plural gaps G (see FIG. 3). For clarification and brevity, only a gap G is shown in the drawing. The light-guiding dots 2211 are used for guiding the plural light beams to the keycaps 201. A process of forming the light-guiding dots 2211 will be illustrated as follows.

Firstly, a stencil with plural mesh openings is placed on a bottom surface 222 of the light guide plate 22. Then, light-guiding ink is poured to the stencil, so that the light-guiding ink flows to the bottom surface 222 of the light guide plate 22 through the mesh openings. Then, the light-guiding ink is subject to a printing process, so that the light-guiding ink is printed on the bottom surface 222 of the light guide plate 22 to result in plural light-guiding dots 2211. As shown in FIG. 3, each of the light-guiding zones 221 that is formed by using the stencil with plural mesh openings comprises plural light-guiding dots 2211, wherein every two light-guiding dots 2211 are spaced from each other by the gap G

As shown in FIG. 2, the reflector 25 of the illuminated keyboard 2 is disposed under the light guide plate 22 for reflecting the light beams. The base plate 26 is disposed under the reflector 25 for supporting the keycap 201, the key housing 202, the elastic element 203, the membrane switch circuit member 21, the light guide plate 22 and the reflector 25.

In the conventional illuminated keyboard 2, the keycap 201 has a light-transmissible region 2011. The light-transmissible region 2011 is located at a character region or a symbol region of the keycap 201. Moreover, the position of the light-transmissible region 2011 is aligned with a corresponding light-guiding zone 221 of the light guide plate 22. In such way, the light beams can be guided to the light-transmissible region 2011 through the light-guiding dots 2211 of the light-guiding zone 221, thereby illuminating the character region or the symbol region of the keycap 201. Consequently, the illuminating efficacy is achieved.

However, after the conventional illuminated keyboard 2 is used for a long time period, some drawbacks occur. For example, since the plural keys 20 are frequently depressed, the light-guiding dots 2211 of the light guide plate 22 will be suffered from abrasion. Since there is a vacant space G between adjacent light-guiding dots 2211, the possibility of abrading the peripheries of the light-guiding dots 2211 will be increased. In addition, the abrasion at the periphery of the light-guiding zone 221 becomes more serious. Under this circumstance, these light-guiding dots 2211 fail to be uniformly distributed, and thus the light-guiding efficacy thereof is deteriorated. Moreover, as shown in FIG. 2, in the vertical direction, the key intersection of the membrane switch circuit member 21 is partially overlapped with some of the light-guiding dots 2211. Under this circumstance, the light beams guided by the light-guiding dots 2211 are partially sheltered by the corresponding key intersections. In other words, some of the light beams are useless, and thus the utilization of the light beams is reduced.

### SUMMARY OF THE INVENTION

The present invention provides an illuminated keyboard for enhancing the utilization of the light beams without resulting in useless light beams.

In accordance with an aspect of the present invention, there is provided an illuminated keyboard. The illuminated keyboard includes plural keys, a membrane switch circuit member, and a light guide plate. The membrane switch circuit member has plural key intersections corresponding to respective keys. The illumination module is arranged at a first side of the membrane switch circuit member for emitting plural light beams. The light guide plate is stacked on the membrane switch circuit module and disposed under the membrane switch circuit module. The light guide plate includes plural light-guiding zones, and the plural light-guiding zones are formed on a bottom surface of the light guide plate. At least one light-guiding zone of the plural light-guiding zones has a light-guiding structure. The light-guiding structure is located below the corresponding key intersection for guiding the plural light beams to the plural keys. Moreover, the light-guiding structure of the at least one light-guiding zone is not aligned with the corresponding key intersection.

In an embodiment, the light-guiding structure is made of light-guiding ink. The light-guiding structure is a light-guiding layer by filling the at least one light-guiding zone with the light-guiding ink, or the light-guiding structure is a light-guiding dot by uniformly distributing the light-guiding ink on the at least one light-guiding zone.

In an embodiment, the light guide plate includes plural additional light-guiding zones, and the plural additional light-guiding zones are formed on the bottom surface of the light guide plate. At least one additional light-guiding zone of the plural additional light-guiding zones is located beside a corresponding key intersection, and has an additional light-guiding structure for guiding the plural light beams to the plural keys. The additional light-guiding structure of the at least one additional light-guiding zone is not aligned with the corresponding key intersection.

In an embodiment, the illuminated keyboard further includes a main circuit board and a base plate. The main circuit board is connected with the membrane switch circuit member and the illumination module for providing first electric power to the membrane switch circuit member and the illumination module. The base plate is disposed under the light guide plate for supporting the plural keys, the membrane switch circuit member, the illumination module, the light guide plate and the main circuit board.

In an embodiment, the illumination module includes an illumination circuit board and plural light-emitting elements. The illumination circuit board is arranged at the first side of the membrane switch circuit member for providing second electric power. The plural light-emitting elements are mounted on the illumination circuit board for acquiring the second electric power, thereby emitting the plural light beams.

In an embodiment, the membrane switch circuit member includes an upper wiring board, a partition plate, and a lower wiring board. The upper wiring board has plural upper contacts. The partition plate is disposed under the upper wiring board, and has plural partition plate openings corresponding to the plural upper contacts. When the membrane switch circuit module is depressed, a corresponding upper contact is inserted into a corresponding partition plate opening The lower wiring board is disposed under the partition plate, and has plural lower contacts corresponding to the plural upper contacts. The plural lower contacts and the plural upper contacts are collectively defined as the plural key intersections.

In accordance with another aspect of the present invention, there is provided an illuminated keyboard. The illuminated keyboard includes plural keys, a membrane switch circuit member, and an illumination module. The membrane switch circuit member has plural key intersections corresponding to respective keys, and plural light-guiding zones. The plural light-guiding zones are formed on a bottom surface of the membrane switch circuit member. At least one light-guiding zone of the plural light-guiding zones has a light-guiding structure. The light-guiding structure is located below the corresponding key intersection for guiding the plural light beams to the plural keys. Moreover, the light-guiding structure of the at least one light-guiding zone is not aligned with the corresponding key intersection. The illumination module is arranged at a first side of the membrane switch circuit member for emitting plural light beams. After the plural light beams are projected to the aid plural light-guiding zones, the plural light beams are guided to the plural keys by the plural light-guiding zones.

In an embodiment, the light-guiding structure is made of light-guiding ink. The light-guiding structure is a light-guiding layer by filling the at least one light-guiding zone with the light-guiding ink, or the light-guiding structure is a light-guiding dot by uniformly distributing the light-guiding ink on the at least one light-guiding zone.

In an embodiment, the light guide plate includes plural additional light-guiding zones, and the plural additional light-guiding zones are formed on the bottom surface of the light guide plate. At least one additional light-guiding zone of the plural additional light-guiding zones is located beside a corresponding key intersection, and has an additional light-guiding structure for guiding the plural light beams to the plural keys. The additional light-guiding structure of the at least one additional light-guiding zone is not aligned with the corresponding key intersection.

In an embodiment, the membrane switch circuit member includes an upper wiring board, a partition plate, and a lower wiring board. The upper wiring board has plural upper contacts. The partition plate is disposed under the upper wiring board, and has plural partition plate openings corresponding to the plural upper contacts. When the membrane switch circuit module is depressed, a corresponding upper contact is inserted into a corresponding partition plate opening The lower wiring board is disposed under the partition plate, and has plural lower contacts corresponding to the plural upper contacts and the plural light-guiding zones. The plural lower contacts and the plural upper contacts are collectively defined as the plural key intersections. The plural light-guiding zones are formed on a bottom surface of the lower wiring board.

In an embodiment, the illuminated keyboard further includes a main circuit board and a base plate. The main circuit board is connected with the membrane switch circuit member and the illumination module for providing first electric power to the membrane switch circuit member and the illumination module. The base plate is disposed under the membrane switch circuit member for supporting the plural keys and the membrane switch circuit member.

In an embodiment, each of the keys includes a keycap, a scissors-type connecting element, and an elastic element. The keycap is exposed to a surface of the illuminated keyboard, and includes a light-transmissible region corresponding to one of the plural light-guiding zones. The scissors-type connecting element is arranged between the base plate and the keycap for connecting the base plate and the keycap, and allowing the keycap to be moved upwardly and downwardly relative to the base plate. The elastic element is arranged between the membrane switch circuit module and the keycap. When the keycap is depressed, the elastic element is compressed to push against the membrane switch circuit module, so that a corresponding upper contact is contacted with a corresponding lower contact. Whereas, when a depressing force exerted on the keycap is eliminated, an elastic force provided by the elastic element is acted on the keycap, so that the keycap is returned to an original position.

In an embodiment, the illumination module includes an illumination circuit board and plural light-emitting elements. The illumination circuit board is arranged at the first side of the membrane switch circuit member for providing second electric power. The plural light-emitting elements are mounted on the illumination circuit board for acquiring the second electric power, thereby emitting the plural light beams.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outward appearance of a conventional keyboard;

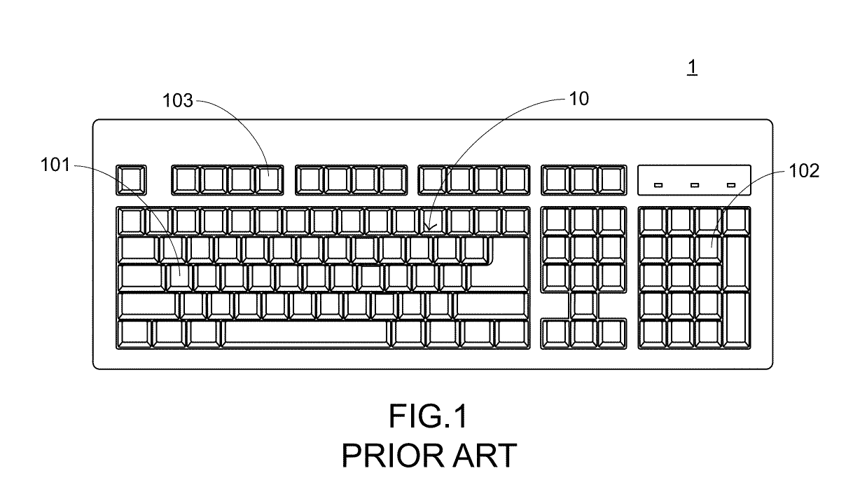

FIG. 2 is a schematic cross-sectional view illustrating a conventional illuminated keyboard;

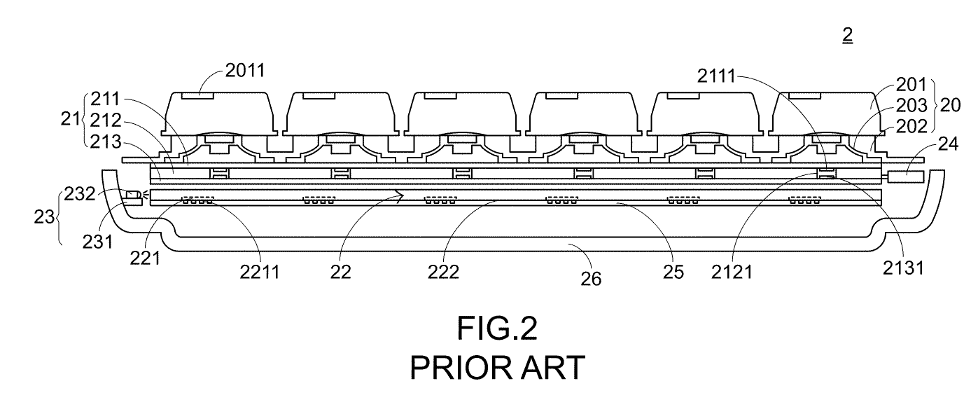

FIG. 3 is a schematic top view illustrating a light guide plate of a conventional illuminated keyboard;

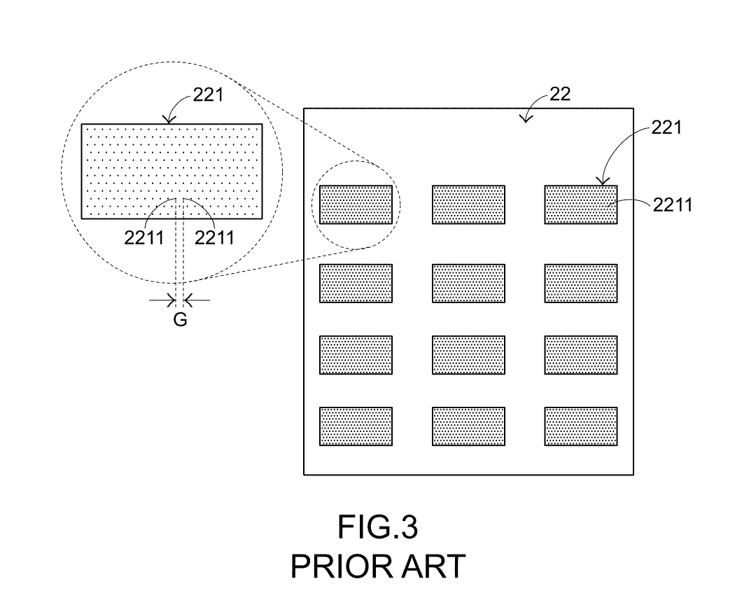

FIG. 4 is a schematic cross-sectional view illustrating an illuminated keyboard according to a first embodiment of the present invention;

FIG. 5 is a schematic exploded view illustrating the membrane switch circuit module, the light guide plate and the illumination module of the illuminated keyboard according to the first embodiment of the present invention;

FIG. 6 is a schematic exploded view illustrating the membrane switch circuit module, the light guide plate and the illumination module of the illuminated keyboard according to a second embodiment of the present invention;

FIG. 7 is a schematic cross-sectional view illustrating an illuminated keyboard according to a third embodiment of the present invention;

FIG. 8 is a schematic exploded view illustrating the membrane switch circuit module and the illumination module of the illuminated keyboard according to the third embodiment of the present invention; and

FIG. 9 is a schematic exploded view illustrating the membrane switch circuit module and the illumination module of the illuminated keyboard according to a fourth embodiment of the present invention.

### DETAILED DESCRIPTION OF THE PREFERRED EMBODIMENT

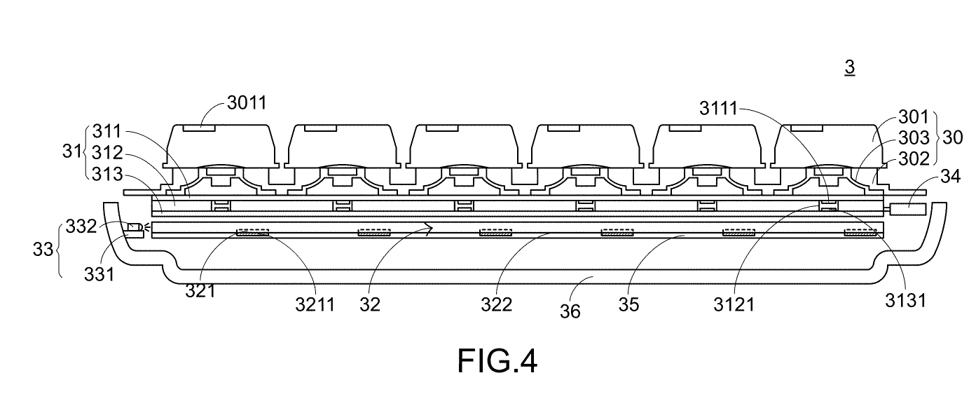

For obviating the drawbacks encountered from the prior art, the present invention provides an illuminated keyboard. FIG. 4 is a schematic cross-sectional view illustrating an illuminated keyboard according to a first embodiment of the present invention. As shown in FIG. 4, the illuminated keyboard 3 comprises plural keys 30, a membrane switch circuit member 31, a light guide plate 32, an illumination module 33, a main circuit board 34, a reflector 35, and a base plate 36. The key 30 comprises a keycap 301, a key housing 302, and an elastic element 303. From top to bottom, the keycap 301, the key housing 302, the elastic element 303, the membrane switch circuit member 31, the light guide plate 32, the reflector 35 and the base plate 36 of the conventional illuminated keyboard 3 are sequentially shown. The illumination module 33 is arranged at a first side of the membrane switch circuit member 31. The main circuit board 34 is arranged at a second side of the membrane switch circuit member 31. In this embodiment, the illuminated keyboard 3 is a keyboard for a desktop computer. The first side of the membrane switch circuit member 31 denotes the rear side of the membrane switch circuit member 31, i.e. the side of the illuminated keyboard 3 including the function key Fl. The second side of the membrane switch circuit member 31 denotes the front side of the membrane switch circuit member 31, i.e. the side of the illuminated keyboard 3 including the space bar.

In the key 30, the keycap 301 is exposed outside the surface of the illuminated keyboard 3, so that the keycap 301 can be depressed by the user. In addition, the keycap 301 has a light-transmissible region 3011. The light-transmissible region 3011 is located at a character region or a symbol region of the keycap 301. The key housing 302 is used for fixing the keycap 301 and the elastic element 303. The elastic element 303 is penetrated through the key housing 302. In addition, both ends of the elastic element 303 are contacted with the keycap 301 and the membrane switch circuit member 31, respectively. In this embodiment, the elastic element 303 is made of a transparent rubbery material. Moreover, the membrane switch circuit module 31 is connected with the main circuit board 34 for transmitting the first electric power and signals.

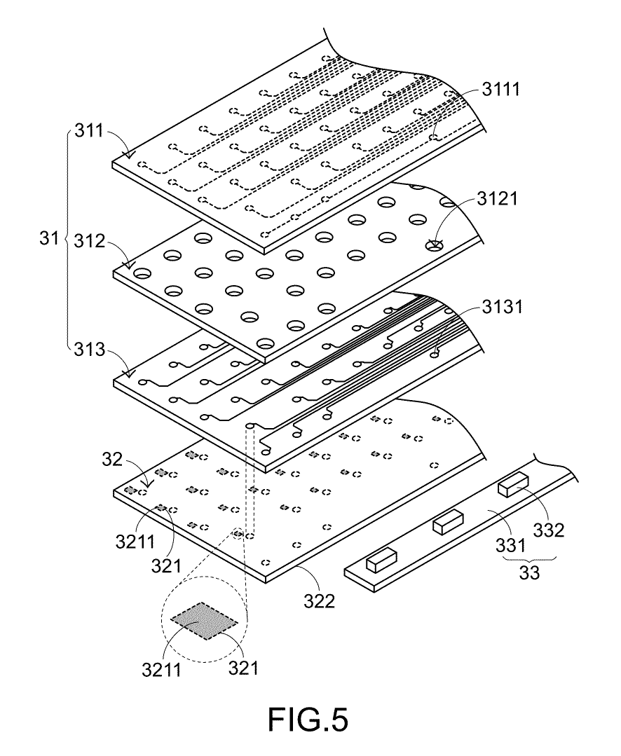

FIG. 5 is a schematic exploded view illustrating the membrane switch circuit module, the light guide plate and the illumination module of the illuminated keyboard according to the first embodiment of the present invention. The membrane switch circuit module 31 comprises an upper wiring board 311, a partition plate 312, and a lower wiring board 313. The upper wiring board 311 has plural upper contacts 3111. The partition plate 312 is disposed under the upper wiring board 311, and comprises plural partition plate openings 3121 corresponding to the plural upper contacts 3111. The lower wiring board 313 is disposed under the partition plate 312, and comprises plural lower contacts 3131 corresponding to the plural upper contacts 3111. The plural lower contacts 3131 and the plural upper contacts 3111 are collectively defined as plural key intersections. In this embodiment, each of the upper wiring board 311, the partition plate 312 and the lower wiring board 313 is made of a transparent material such as polycarbonate (PC) or polyethylene (PE).

Please refer to FIGS. 4 and 5 again. The illumination module 33 comprises an illumination circuit board 331 and plural light-emitting elements 332. The illumination circuit board 331 is arranged at the first side of the membrane switch circuit member 31 for providing second electric power to the plural light-emitting elements 332. The plural light-emitting elements 332 are mounted on the illumination circuit board 331. By acquiring the second electric power, the plural light-emitting elements 332 are enabled to emit plural light beams. The light guide plate 32 has plural light-guiding zones 321. At least one light-guiding zone 321 of the light-guiding zones 321 comprises a light-guiding structure 3211. The at least one light-guiding zone 321 is located beside a corresponding key intersection. By the light-guiding structure 3211, the plural light beams are guided to the plural keys 30. In this embodiment, the illumination circuit board 331 is a rigid printed circuit (RPC) board. Moreover, the plural light-emitting elements 332 are side-view light-emitting diodes. It is noted that one light-guiding zone 321 does not necessarily correspond to one key intersection. The light-guiding structure 3211 is a light-guiding layer by filling the at least one light-guiding zone 321 with a light-guiding ink. That is, the at least one light-guiding zone 321 is filled with the corresponding light-guiding layer 3211 without forming any vacant space. In this embodiment, the at least one light-guiding zones 321 and the light-guiding layers 3211 are all rectangular. Alternatively, in some embodiments, the illumination circuit board 331 is a flexible printed circuit (FPC) board.

Hereinafter, three special aspects of this embodiment will be described. In the first special aspect, the plural light-emitting elements 332 are located at the first side of the membrane switch circuit member 31. Consequently, the region near the plural light-emitting elements 332 can be emitted by the great portions of light beams. In other words, the light-guiding zones 321 corresponding to the plural key intersections which are near the first side of the membrane switch circuit member 31 may be largely reduced or omitted. Under this circumstance, the great portions of light beams are sufficiently projected to the corresponding keys 30 to illuminate the keys 30. In addition, the areas of the light-guiding zones 321 corresponding to the plural key intersections which are near the second side of the membrane switch circuit member 31 are relatively higher. Whereas, as the distance from the plural light-emitting elements 332 is increased, the areas of the light-guiding zones 321 corresponding to the key intersections between the first side and the second side of the membrane switch circuit member 31 are increased. Consequently, the illuminating efficacy of the illuminated keyboard 3 is more uniform. Of course, the light-guiding structures adjacent to the plural light-emitting elements 332 may be light-guiding dots, which are uniformly distributed on the light-guiding zones by a conventional printing process. In other words, the light-guiding structures are not restricted to the light-guiding layers of the light-guiding zones.

In the second special aspect, the process of forming each of the light-guiding layers 3211 is similar to the conventional process of forming the light-guiding dots. Firstly, a stencil with plural rectangular openings is placed on a bottom surface 322 of the light guide plate 32. Then, light-guiding ink is poured to the stencil, so that the light-guiding ink flows to the bottom surface 322 of the light guide plate 32 through the plural rectangular openings. Then, the light-guiding ink is subject to a printing process, so that the light-guiding ink is printed on the bottom surface 322 of the light guide plate 32 to result in plural rectangular light-guiding layers 3211. Since the light-guiding layer 3211 is formed by completely filling the rectangular opening with the light-guiding ink, the light-guiding zone 321 is filled with the corresponding light-guiding layer 3211. Under this circumstance, no vacant space is formed in the at least one light-guiding zone 321.

In the third special aspect, the plural light-guiding zones 321 are disposed on the bottom surface 322 of the light guide plate 32. Moreover, the light-guiding zones 321 are located beside corresponding key intersections, and the light-guiding zones 321 and the corresponding key intersections are not overlapped with each other. That is, the light-guiding structure 3211 (i.e. the light-guiding layer) of the at least one light-guiding zone 321 is not aligned with the corresponding key intersection. Under this circumstance, the light beams guided by the light-guiding layers 3211 are not sheltered by the corresponding key intersections. In other words, the light beams can be fully utilized, and thus the utilization of the light beams is enhanced.

As shown in FIG. 4, the reflector 35 is disposed under the light guide plate 32 for reflecting the light beams. The base plate 36 is disposed under the reflector 35 for supporting the keycap 301, the key housing 302, the elastic element 303, the membrane switch circuit member 31, the light guide plate 32 and the reflector 35. When the keycap 301 is depressed by a user, the keycap 301 is moved downwardly with respect to the key housing 302. At the same time, the elastic element 303 is compressed to push against the membrane switch circuit member 31, so that the upper contact 3111 is inserted into a corresponding partition plate opening 3121 to be contacted with a corresponding lower contact 3131. Under this circumstance, a corresponding key intersection of the membrane switch circuit module 31 is triggered to generate a key signal. Whereas, when the depressing force exerted on the key 301 is eliminated, an elastic force provided by the elastic element 303 is acted on the keycap 341. Due to the elastic force, the keycap 301 is returned to its original position. After the plural light beams emitted by the plural light-emitting elements 322 of the illumination module 32 are directed to the light guide plate 32, some of the light beams are guided to the light-transmissible regions 3011 of the keycaps 301 by the plural light-guiding layers 3211 of the light guide plate 32. At the same time, some of the light beams are reflected by the reflector 35 under the light guide plate 32, and the reflected light beams are directed to the light-guiding layers 3211 again to be guided by the light-guiding layers 3211.

From the above discussions, the light-guiding layer 3211 is an integral rectangular layer. In other words, the peripheries of the light-guiding layer 3211 are the four sides of the rectangle. In comparison with the light-guiding dots 2211 of the light-guiding zone 221, since the rectangular light-guiding layer 3211 has no vacant space, the peripheries of the light-guiding layer 3211 are the four sides of the rectangle. Moreover, since the peripheries of the light-guiding layer 3211 are smaller than the peripheries of the plural light-guiding dots 2211, the possibility of abrading the light-guiding layer 3211 through a long-term collision will be reduced. Moreover, since the light-guiding layer 3211 is rectangular and the stencil for performing the printing process have the same size of rectangular openings as the light-guiding zones 321, the rectangular openings can be easily filled with the light-guiding ink during the printing process. Moreover, after the printing process is finished, the light-guiding ink is seldom retained in the stencil with the rectangular openings. On contrast, since the conventional stencil for forming the light-guiding dots has small mesh openings, the light-guiding ink is easily retained in the stencil. Moreover, in a case that the conventional stencil with the small mesh openings is repeatedly used, a portion of the light-guiding ink to be printed on the light-guiding zone may be adsorbed or bonded by the residual light-guiding ink of the stencil. Under this circumstance, the light-guiding ink printed on the light-guiding zone is insufficient, and thus the light-guiding efficacy thereof is deteriorated. On the other hand, since stencil of the present invention for printing the light-guiding ink has larger-sized rectangular openings, the light-guiding ink is rarely retained in the stencil during the process of forming the light-guiding layer of the present invention. Since the light-guiding ink is filled with the light-guiding zone, the light-guiding efficacy is enhanced. In addition, the production yield during the printing process is increased, and the fabricating cost is reduced.

Moreover, the plural light-guiding zones 321 are disposed on the bottom surface 322 of the light guide plate 32, and the light-guiding zones 321 and the corresponding key intersections are not overlapped with each other. Under this circumstance, the light beams guided by the light-guiding layers 3211 are not sheltered by the corresponding key intersections. In other words, the light beams can be fully utilized, and thus the utilization of the light beams is enhanced.

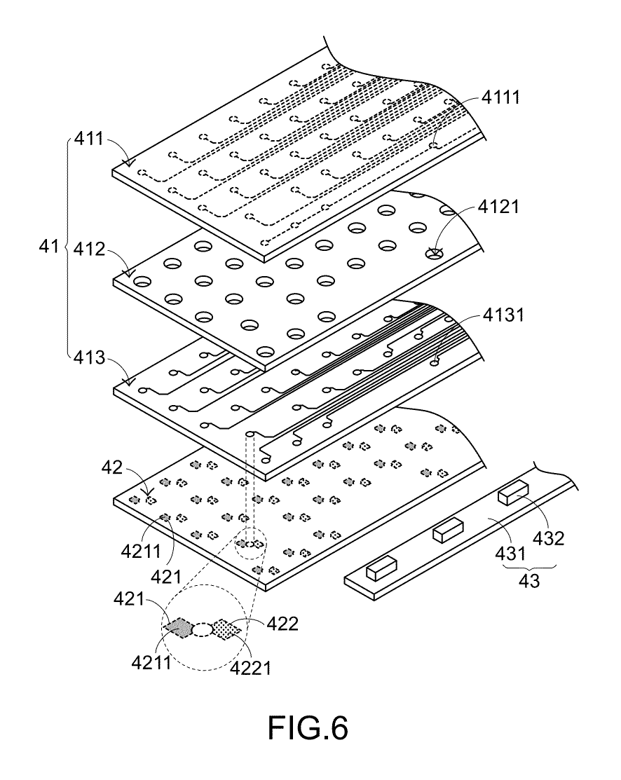

The present invention further provides an illuminated keyboard of a second embodiment. FIG. 6 is a schematic exploded view illustrating the membrane switch circuit module, the light guide plate and the illumination module of the illuminated keyboard according to a second embodiment of the present invention. Like the illuminated keyboard of the first embodiment, the illuminated keyboard as shown in FIG. 6 comprises plural keys (not shown), a membrane switch circuit member 41, a light guide plate 42, an illumination module 43, a main circuit board (not shown), a reflector (not shown), and a base plate (not shown). The membrane switch circuit module 41 comprises an upper wiring board 411, a partition plate 412, and a lower wiring board 413. The upper wiring board 411 has plural upper contacts 4111. The partition plate 412 is disposed under the upper wiring board 411, and comprises plural partition plate openings 4121 corresponding to the plural upper contacts 4111. The lower wiring board 413 is disposed under the partition plate 412, and comprises plural lower contacts 4131 corresponding to the plural upper contacts 4111. The plural lower contacts 4131 and the plural upper contacts 4111 are collectively defined as plural key intersections. The illumination module 43 comprises an illumination circuit board 431 and plural light-emitting elements 432. The illumination module 43 is arranged at the first side of the membrane switch circuit member 41 for providing second electric power to the plural light-emitting elements 432. The plural light-emitting elements 432 are mounted on the illumination circuit board 431. By acquiring the second electric power, the plural light-emitting elements 432 are enabled to emit plural light beams.

In comparison with the first embodiment, the light guide plate 42 comprises plural light-guiding zones 421 and plural additional light-guiding zones 422. At least one light-guiding zone 421 of the plural light-guiding zones 421 comprises a light-guiding structure 4211. At least one additional light-guiding zone 422 of the plural additional light-guiding zones 422 comprises an additional light-guiding structure 4221. In this embodiment, one light-guiding zone 421 and one additional light-guiding zone 422 correspond to one key intersection. It is noted that one light-guiding zone 421 and one additional light-guiding zone 422 do not necessarily correspond to one key intersection. Moreover, in the vertical direction, the at least one light-guiding zone 421 and the at least one additional light-guiding zone 422 are partially overlapped with the corresponding key intersection.

For avoiding reduction of the light utilization, the light-guiding structure 4211 of the at least one light-guiding zone 421 is not aligned with the corresponding key intersection. That is, the light-guiding structure 4211 is not included in the overlapped region between the light-guiding zone 421 and the corresponding key intersection. Consequently, the light-guiding structure 4211 of the light-guiding zone 421 has a notch (i.e. a one-fourth circular notch) corresponding to the key intersection (see FIG. 6). Similarly, the additional light-guiding structure 4221 of the at least one additional light-guiding zone 422 is not aligned with the corresponding key intersection. That is, the additional light-guiding structure 4221 is not included in the overlapped region between the additional light-guiding zone 422 and the corresponding key intersection. Consequently, the additional light-guiding structure 4212 of the additional light-guiding zone 422 has a notch (i.e. a one-fourth circular notch) corresponding to the key intersection (see FIG. 6). In this embodiment, the light-guiding structure 4211 is a light-guiding layer by filling the at least one light-guiding zone 421 with a light-guiding ink, so that the at least one light-guiding zone 421 is filled with the corresponding light-guiding layer 4211 without forming any vacant space. Whereas, the additional light-guiding structure 4221 is a light-guiding dot by uniformly distributing the light-guiding ink on the at least one additional light-guiding zone 421. Under this circumstance, the light beams of the illuminated keyboard of a third embodiment can be fully utilized, and the light utilization will not be impaired.

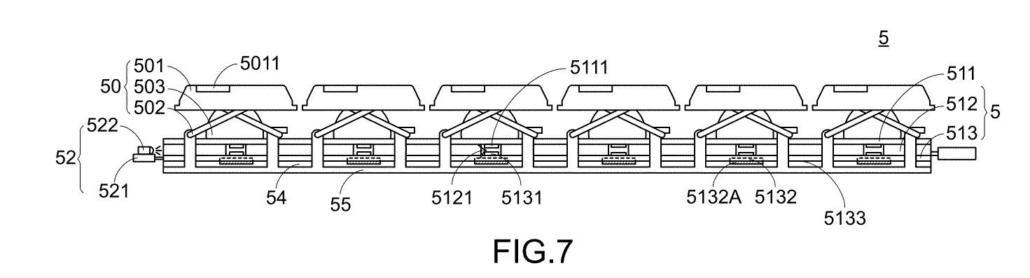

The present invention further provides an illuminated keyboard of a third embodiment. FIG. 7 is a schematic cross-sectional view illustrating an illuminated keyboard according to a third embodiment of the present invention. As shown in FIG. 7, the illuminated keyboard 5 comprises plural keys 50, a membrane switch circuit member 51, an illumination module 52, a main circuit board 53, a reflector 54, and a base plate 55. The key 50 comprises a keycap 501, a scissors-type connecting element 502, and an elastic element 503. From top to bottom, the keycap 501, the scissors-type connecting element 502, the elastic element 503, the membrane switch circuit member 51, the reflector 54 and the base plate 55 of the conventional illuminated keyboard 5 are sequentially shown. The illumination module 52 is arranged at a first side of the membrane switch circuit member 51. The main circuit board 53 is arranged at a second side of the membrane switch circuit member 51. In this embodiment, the illuminated keyboard 5 is a keyboard for a notebook computer. The first side of the membrane switch circuit member 51 denotes the rear side of the membrane switch circuit member 51, i.e. the side of the illuminated keyboard 5 including the function key Fl. The second side of the membrane switch circuit member 51 denotes the front side of the membrane switch circuit member 51, i.e. the side of the illuminated keyboard 5 including the space bar.

In the key 50, the keycap 501 is exposed outside the surface of the illuminated keyboard 5, so that the keycap 501 can be depressed by the user. In addition, the keycap 501 has a light-transmissible region 5011. The light-transmissible region 5011 is located at a character region or a symbol region of the keycap 501. The scissors-type connecting element 502 is connected with the keycap 501 and the base plate 55. The elastic element 503 is penetrated through the scissors-type connecting element 502. In addition, both ends of the elastic element 503 are contacted with the keycap 501 and the membrane switch circuit member 51, respectively. Moreover, the membrane switch circuit module 51 is connected with the main circuit board 53 for transmitting electric power and signals.

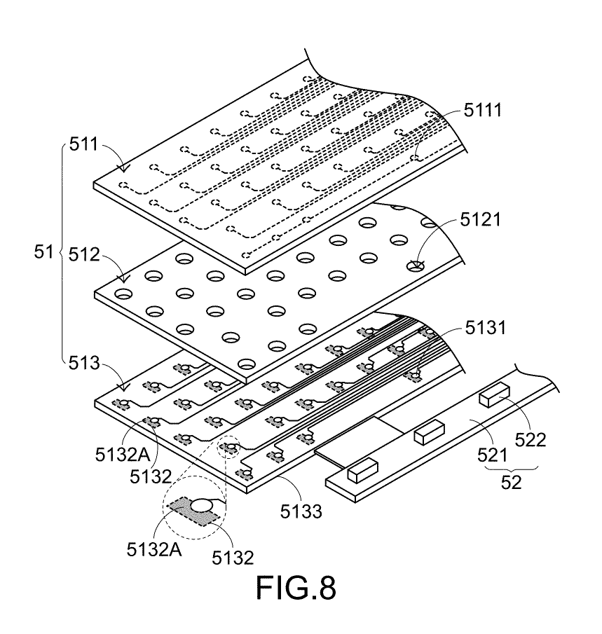

FIG. 8 is a schematic exploded view illustrating the membrane switch circuit module and the illumination module of the illuminated keyboard according to the third embodiment of the present invention. As shown in FIG. 8, the membrane switch circuit module 51 comprises an upper wiring board 511, a partition plate 512, and a lower wiring board 513. The upper wiring board 511 has plural upper contacts 5111. The partition plate 512 is disposed under the upper wiring board 511, and comprises plural partition plate openings 5121 corresponding to the plural upper contacts 5111. The lower wiring board 513 is disposed under the partition plate 512. In addition, the lower wiring board 513 comprises plural lower contacts 5131 corresponding to the plural upper contacts 5111, and plural light-guiding zones 5132. The plural lower contacts 5131 and the plural upper contacts 5111 are collectively defined as plural key intersections. The plural light-guiding zones 5132 are formed on a bottom surface of the membrane switch circuit module 51 (i.e. the bottom surface 5133 of the lower wiring board 513). At least one light-guiding zone 5132 of the light-guiding zones 5132 comprises a light-guiding structure 5132A. The at least one light-guiding zone 5132 is located beside a corresponding key intersection, and the light-guiding structure 5132A is used for guiding the plural light beams to the plural keys. Moreover, in the vertical direction, the at least one light-guiding zone 5132 is partially overlapped with the corresponding key intersection.

In this embodiment, one light-guiding zone 5132 corresponds to one key intersection. It is noted that one light-guiding zone 5132 does not necessarily correspond to one key intersection. The light-guiding structure 5132A is a light-guiding layer by filling the at least one light-guiding zone 5132 with a light-guiding ink. That is, the at least one light-guiding zone 5132 is filled with the corresponding light-guiding layer 5132A without forming any vacant space. In this embodiment, the at least one light-guiding zones 5132 and the light-guiding layers 5132A are all rectangular. Each of the upper wiring board 511 and the partition plate 512 are made of a transparent material such as polycarbonate (PC) or polyethylene (PE). Whereas, the lower wiring board 513 is made of a light-guiding material such as polycarbonate (PC) or polymethylmethacrylate (PMMA). The light-guiding layers 5132A are formed by printing light-guiding ink on the bottom surface 5133 of the light lower wiring board 513. The printing process is similar to that of the first embodiment, and is not redundantly described herein.

Hereinafter, two special aspects of this embodiment will be described. In the first special aspect, the upper wiring board 511, the partition plate 512 and the lower wiring board 513 have respective perforations, and some portions of the base plate 55 are penetrated through corresponding perforations. For cleaning the drawing and facilitating observing the light-guiding structures, the perforations to be penetrated through by the base plate 55 are not shown in FIG. 8. In the second special aspect, for avoiding reduction of the light utilization, the light-guiding structure 5132A of the at least one light-guiding zone 5132 is not aligned with the corresponding key intersection. That is, the light-guiding structure 5132A is not included in the overlapped region between the light-guiding zone 5132 and the corresponding key intersection. Consequently, the light-guiding structure 5132A of the light-guiding zone 5132 has a semi-circular notch corresponding to the key intersection (see FIG. 8). Under this circumstance, the light beams can be fully utilized, and the light utilization will not be impaired.

Please refer to FIGS. 7 and 8 again. The illumination module 52 comprises an illumination circuit board 521 and plural light-emitting elements 522. The illumination circuit board 531 is arranged at the first side of the membrane switch circuit member 51 for providing second electric power to the plural light-emitting elements 522. The plural light-emitting elements 522 are mounted on the illumination circuit board 521. By acquiring the second electric power, the plural light-emitting elements 522 are enabled to emit plural light beams. In this embodiment, the plural light-emitting elements 522 are side-view light-emitting diodes. Moreover, the illumination circuit board 521 is a flexible printed circuit (FPC) board. The reflector 54 is disposed under the membrane switch circuit module 51 light guide plate 32 for reflecting the plural light beams. The base plate 55 is disposed under the reflector 54 and connected with the scissors-type connecting element 502. The base plate 55 is used for supporting the keycap 501, the scissors-type connecting element 502, the elastic element 503, the membrane switch circuit member 51 and the reflector 54. The operations of the illuminated keyboard 5 of this embodiment are similar to those illustrated in the first embodiment, and are not redundantly described herein. Alternatively, in some embodiments, the illumination circuit board 521 is a rigid printed circuit (RPC) board.

The light-guiding layer 5132A of the illuminated keyboard 5 of this embodiment has benefits similar to the first embodiment. That is, the possibility of abrading the light-guiding layer 5132A is minimized and the fabricating cost of the illuminated keyboard 5 is reduced. Moreover, since the light-guiding layer 5132A is formed on the on the bottom surface 5133 of the light lower wiring board 513 of the membrane switch circuit member 51 in this embodiment, no additional light guide plate is required. Under this circumstance, the internal thickness of the illuminated keyboard 5, and the internal structure of the illuminated keyboard 5 is simplified. Therefore, the illuminated keyboard 5 is easily assembled and the fabricating cost thereof is reduced.

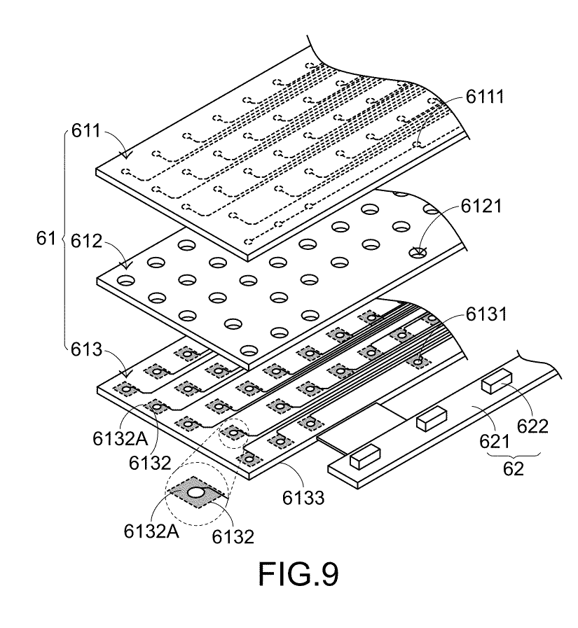

The present invention further provides an illuminated keyboard of a fourth embodiment. FIG. 9 is a schematic exploded view illustrating the membrane switch circuit module and the illumination module of the illuminated keyboard according to a fourth embodiment of the present invention. Like the illuminated keyboard of the third embodiment, the illuminated keyboard as shown in FIG. 9 comprises plural keys (not shown), a membrane switch circuit member 61, an illumination module 62, a main circuit board (not shown), a reflector (not shown), and a base plate (not shown). As shown in FIG. 9, the membrane switch circuit module 61 comprises an upper wiring board 611, a partition plate 612, and a lower wiring board 613. The upper wiring board 611 has plural upper contacts 6111. The partition plate 612 is disposed under the upper wiring board 611, and comprises plural partition plate openings 6121 corresponding to the plural upper contacts 6111. The lower wiring board 613 is disposed under the partition plate 612. In addition, the lower wiring board 613 comprises plural lower contacts 6131 corresponding to the plural upper contacts 6111, and plural light-guiding zones 6132. The plural lower contacts 6131 and the plural upper contacts 6111 are collectively defined as plural key intersections. The configurations and relationships of the other components of the illuminated keyboard of the third embodiment, and are not redundantly described herein.

Please refer to FIG. 9 again. The plural light-guiding zones 6132 of the lower wiring board 613 are formed on a bottom surface of the membrane switch circuit module 61 (i.e. the bottom surface 6133 of the lower wiring board 613). At least one light-guiding zone 6132 of the light-guiding zones 6132 comprises a light-guiding structure 6132A. In comparison with the illuminated keyboard of the third embodiment, the at least one light-guiding zone 6132 is located under a corresponding key intersection, and the light-guiding structure 6132A is used for guiding the plural light beams to the plural keys. Moreover, in the vertical direction, the at least one light-guiding zone 6132 is overlapped with the corresponding key intersection.

In this embodiment, one light-guiding zone 6132 corresponds to one key intersection. It is noted that one light-guiding zone 6132 does not necessarily correspond to one key intersection. The light-guiding structure 6132A is a light-guiding layer by filling the at least one light-guiding zone 6132 with a light-guiding ink. That is, the at least one light-guiding zone 6132 is filled with the corresponding light-guiding layer 6132A without forming any vacant space. For avoiding reduction of the light utilization, the light-guiding structure 6132A of the at least one light-guiding zone 6132 is not aligned with the corresponding key intersection. That is, the light-guiding structure 6132A is not included in the overlapped region between the light-guiding zone 6132 and the corresponding key intersection. Consequently, the light-guiding structure 6132A of the light-guiding zone 6132 has a hole (i.e. a circular hole) corresponding to the key intersection (see FIG. 9). Under this circumstance, the light beams can be fully utilized, and the light utilization will not be impaired.

From the above description, the illuminated keyboard of the present invention utilizes light-guiding structures to guide the light beams. Since the light-guiding structures are not aligned with corresponding key intersections, the light beams guided by the light-guiding structures are not sheltered by the corresponding key intersections. Consequently, the illuminating efficacy of the illuminated keyboard is maintained, and the light utilization is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An illuminated keyboard, comprising:
plural keys;
a membrane switch circuit member having plural key intersections corresponding to respective keys;
an illumination module arranged at a first side of said membrane switch circuit member for emitting plural light beams; and
a light guide plate stacked on said membrane switch circuit module and disposed under said membrane switch circuit module, wherein said light guide plate comprises plural light-guiding zones, and said plural light-guiding zones are formed on a bottom surface of said light guide plate, wherein at least one light-guiding zone of said plural light-guiding zones has a light-guiding structure, and said light-guiding structure is located below said corresponding key intersection for guiding said plural light beams to said plural keys, wherein said light-guiding structure of said at least one light-guiding zone is not aligned with said corresponding key intersection.

2. The illuminated keyboard according to claim 1 wherein said light-guiding structure is made of light-guiding ink, wherein said light-guiding structure is a light-guiding layer by filling said at least one light-guiding zone with said light-guiding ink, or said light-guiding structure is a light-guiding dot by uniformly distributing said light-guiding ink on said at least one light-guiding zone.

3. The illuminated keyboard according to claim 1 wherein said light guide plate comprises plural additional light-guiding zones, and said plural additional light-guiding zones are formed on said bottom surface of said light guide plate, wherein at least one additional light-guiding zone of said plural additional light-guiding zones is located beside a corresponding key intersection, and has an additional light-guiding structure for guiding said plural light beams to said plural keys, wherein said additional light-guiding structure of said at least one additional light-guiding zone is not aligned with said corresponding key intersection.

4. The illuminated keyboard according to claim 1 further comprising:
a main circuit board connected with said membrane switch circuit member and said illumination module for providing first electric power to said membrane switch circuit member and said illumination module; and
a base plate disposed under said light guide plate for supporting said plural keys, said membrane switch circuit member, said illumination module, said light guide plate and said main circuit board.

5. The illuminated keyboard according to claim 1 wherein said illumination module comprises:
an illumination circuit board arranged at said first side of said membrane switch circuit member for providing second electric power; and
plural light-emitting elements mounted on the illumination circuit board for acquiring said second electric power, thereby emitting said plural light beams.

6. The illuminated keyboard according to claim 1 wherein said membrane switch circuit member comprises:
an upper wiring board having plural upper contacts;
a partition plate disposed under said upper wiring board, and having plural partition plate openings corresponding to said plural upper contacts, wherein when said membrane switch circuit module is depressed, a corresponding upper contact is inserted into a corresponding partition plate opening; and
a lower wiring board disposed under said partition plate, and having plural lower contacts corresponding to said plural upper contacts, wherein said plural lower contacts and said plural upper contacts are collectively defined as said plural key intersections.

7. An illuminated keyboard, comprising:
plural keys;
a membrane switch circuit member having plural key intersections corresponding to respective keys, and plural light-guiding zones, wherein said plural light-guiding zones are formed on a bottom surface of said membrane switch circuit member, wherein at least one light-guiding zone of said plural light-guiding zones has a light-guiding structure, and said light-guiding structure is located below said corresponding key intersection for guiding said plural light beams to said plural keys, wherein said light-guiding structure of said at least one light-guiding zone is not aligned with said corresponding key intersection; and
an illumination module arranged at a first side of said membrane switch circuit member for emitting plural light beams, wherein after said plural light beams are projected to said aid plural light-guiding zones, said plural light beams are guided to said plural keys by said plural light-guiding zones.

8. The illuminated keyboard according to claim 7 wherein said light-guiding structure is made of light-guiding ink, wherein said light-guiding structure is a light-guiding layer by filling said at least one light-guiding zone with said light-guiding ink, or said light-guiding structure is a light-guiding dot by uniformly distributing said light-guiding ink on said at least one light-guiding zone.

9. The illuminated keyboard according to claim 7 wherein said light guide plate comprises plural additional light-guiding zones, and said plural additional light-guiding zones are formed on said bottom surface of said light guide plate, wherein at least one additional light-guiding zone of said plural additional light-guiding zones is located beside a corresponding key intersection, and has an additional light-guiding structure for guiding said plural light beams to said plural keys, wherein said additional light-guiding structure of said at least one additional light-guiding zone is not aligned with said corresponding key intersection.

10. The illuminated keyboard according to claim 7 wherein said membrane switch circuit member comprises:
an upper wiring board having plural upper contacts;
a partition plate disposed under said upper wiring board, and having plural partition plate openings corresponding to said plural upper contacts, wherein when said membrane switch circuit module is depressed, a corresponding upper contact is inserted into a corresponding partition plate opening; and
a lower wiring board disposed under said partition plate, and having plural lower contacts corresponding to said plural upper contacts and said plural light-guiding zones, wherein said plural lower contacts and said plural upper contacts are collectively defined as said plural key intersections, and said plural light-guiding zones are formed on a bottom surface of said lower wiring board.

11. The illuminated keyboard according to claim 7 further comprising:
a main circuit board connected with said membrane switch circuit member and said illumination module for providing first electric power to said membrane switch circuit member and said illumination module; and
a base plate disposed under said membrane switch circuit member for supporting said plural keys and said membrane switch circuit member.

12. The illuminated keyboard according to claim 11, wherein each of said keys comprises:
a keycap exposed to a surface of said illuminated keyboard, and comprising a light-transmissible region corresponding to one of said plural light-guiding zones;
a scissors-type connecting element arranged between said base plate and said keycap for connecting said base plate and said keycap, and allowing said keycap to be moved upwardly and downwardly relative to said base plate; and
an elastic element arranged between said membrane switch circuit module and said keycap, wherein when said keycap is depressed, said elastic element is compressed to push against said membrane switch circuit module, so that a corresponding upper contact is contacted with a corresponding lower contact, wherein when a depressing force exerted on said keycap is eliminated, an elastic force provided by said elastic element is acted on said keycap, so that said keycap is returned to an original position.

13. The illuminated keyboard according to claim 7 wherein said illumination module comprises:
an illumination circuit board arranged at said first side of said membrane switch circuit member for providing second electric power; and
plural light-emitting elements mounted on the illumination circuit board for acquiring said second electric power, thereby emitting said plural light beams.
